(19) United States
(12) Patent Application Publication
(10) Pub. No.: US 2006/0286318 A1
(43) Pub. Date: Dec. 21, 2006

(54) Luminaire

(76) Inventors: Maarten De Leuw, Eindhoven (NL); Hans-Helmut Bechtel, Roetgen (DE); Joachim Opitz, Aachen (DE); Stefan Beikes, Eindhoven (NL); Bas Van Der Heijden, Eindhoven (NL)

Correspondence Address: PHILIPS INTELLECTUAL PROPERTY & STANDARDS, P.O. BOX 3001, BRIARCLIFF MANOR, NY, 10510, US

(21) Appl. No.: 10/552,081

(22) PCT Filed: Mar. 30, 2004
(86) PCT No.: PCT/IB04/50361

§ 371 Date: Oct. 4, 2005

(30) Foreign Application Priority Data
Apr. 7, 2003 (EP) 03100933.5

(51) Int. Cl. B31B 45/00

(52) U.S. Cl. 428/34.1

(57) ABSTRACT

A luminaire comprising at least one light source arranged in a housing for emitting a light beam through a light-transmitting plate of the housing, with the special feature that said housing is provided with a diffuse reflective coating having a water-based solvent and a binder. The binder is on the basis of either a polymer selected from the group formed by compounds of the following structural formula (I): wherein R¹ comprises an element chosen from the group Br, Cl, I, F, H, wherein R² comprises an element chosen from the group Br, Cl, I, F. H, or an alkyl group, wherein R³ comprises an element chosen from the group Br, Cl, I, F, H, or COOCH₃, and wherein R⁴ comprises an element chosen from the group Br, Cl, I, F, H, OH, or vinylether, or an organically modified silane of the sol-gel type, wherein said diffuse reflective coating is applied as a diffuser on the light-transmitting plate.

The invention relates to a luminaire comprising a housing suitable for accommodating at least one light source for emitting a light beam through a light-transmitting plate of the housing.

Such a luminaire as such is generally known. The luminaire is usually a flat light box, such as the light box that is used for visual inspection of X-ray photographs, for realising flat lighting tiles or lighting walls attached to walls or ceilings for general lighting purposes, or for back lighting advertising columns, billboards or LCD screens. As a rule, the light source that is present in the housing of the luminaire is at least partially surrounded by a reflector coated with a reflector coating for reflecting light emitted by the light source in a direction away from the light-transmitting plate back to the light-transmitting plate. An important practical requirement concerning such products is that the reflector coating must absorb such light as little as possible to avoid light losses. Another important requirement in this respect is that light exiting from the light-transmitting plate must exhibit a substantially homogeneous intensity over substantially the entire plate area, so that the location and the shape of the light source—for example in the form of one or more TL tubes in the case of a light box—cannot be distinguished as such from the outside. In order to accomplish this, it is known to apply a light-diffusing coating on the light-transmitting plate, for example by spraying.

A drawback of generally known luminaires is that the reflector coating ages and discolors as time goes by due to ultraviolet (UV) light emitted by the light source, resulting in absorption of light by said coating and in reflection (specular or diffuse) of yellow light by said coating. A further drawback is that also the light-diffusing coating sprayed onto the light-transmitting plate ages and discolors in time as a consequence of said UV light. This leads to a lower diffuse transmission rate and to diffuse transmission of yellow light.

The object of the invention is to overcome these drawbacks of the prior art, and in order to accomplish that objective, according to the invention, a luminaire of the kind as referred to in the introduction may be characterized in that a diffuse reflective coating is provided on an inner side of said housing, the diffuse reflective coating having a water-based solvent and a binder on the basis of a polymer having the following structural formula:
-[—CR¹R²—CR³R⁴—]-
wherein R¹ comprises an element chosen from the group Br, Cl, I, F, H, wherein R² comprises an element chosen from the group Br, Cl, I, F, H, or an alkyl group, wherein R³ comprises an element chosen from the group Br, Cl, I, F, H, or COOCH₃, and wherein R⁴ comprises an element chosen from the group Br, Cl, I, F, H, OH, or vinylether. Such a coating is particularly resistant to UV light and high operating temperatures of the light source, while it shows a very low absorption rate. In order to improve the resistance of the binder to UV light and high temperatures, while enhancing the binding properties of the binder, the latter preferably comprises a polymer in which said structural formula contains at least 30% by weight of Br, Cl, I, F, or COOCH₃.

In one preferred embodiment of a luminaire according to the invention, the diffuse reflective coating is applied as a back reflector on the inner back surface of the housing. The diffuse reflective coating particularly reflects more than 90%, particularly more than 95% of normally incident light thereon. In order to improve UV resistance and mechanical properties of this coating, the diffuse reflective coating is mixed with a polyisocyanate compound so that a chemical cross-linking will take place.

However, for accomplishing the objective mentioned above a luminaire of the kind referred to in the introduction according to the invention may also be characterized in that said housing is provided with a diffuse reflective coating having a network on the basis of an organically modified silane which can be formed by means of a sol-gel process, wherein said diffuse reflective coating is applied as a diffuser on the light-transmitting plate. Said organically modified silane preferably has the following structural formula:
R¹Si(OR^{II})₃
wherein R₁ comprises an alkyl group or an aryl group and wherein R^{II} comprises an alkyl group. Sol-gel chemistry involves the application of a colloidal suspension (sol) of a chemically converted oxide to a substrate with the subsequent evaporation of the suspending medium at room temperature. When a sol-gel method is used to coat a substrate, the coating that is deposited generally requires a final heat cure to convert the coating into the desired oxide. A common curing temperature used in sol-gel applications is approximately 400° C. There are many materials that have melting or decomposition temperatures below 400° C., including, for example, certain plastics and other polymeric resins. Thus, these optical coatings cannot be provided on a large class of coatings substrates (i.e. those with melting points below 400° C.).

In a preferred embodiment of a luminaire according to the invention the solvent comprises at least 80% by weight of water. That means that no environmentally unfriendly solvents are presently used.

The following applies for both types of luminaires in accordance with the invention (that is with a binder on the basis of either a polymer, wherein said structural formula contains at least 30% by weight of the group Br, Cl, I, F or COOCH₃ or an inorganic polymer of the sol-gel type, and wherein said diffuse reflective coating as a diffuser is applied as a diffuser on the light-transmitting plate). When the diff-use reflective coating is applied as a diffuser on the light-transmitting plate, in another preferred embodiment of a luminaire in accordance with the invention, the diffuse reflective coating transmits more than 60%, particularly more than 70% of normally incident back light thereon.

In another preferred embodiment of a luminaire according to the invention, the diffuse reflective coating is provided with a UV-blocking layer. Said layer is particularly applied on one side and/or both sides of the diffuse reflective coating and/or within the diffuse reflective coating. Preferably, said layer comprises a metal oxide chosen from the group of ZnO, M₂O₃ (M being B, Al, Sc, La, or Y) and MO₂ (M being Ce, Ge, Sn, Ti, Zr, or Hf) or a metal phosphate chosen from the group of Mₓ(PO₄)ₙ and Mₓ(PO₃)ₙ (M being an alkali metal, an earth alkali metal, Al, Sc, Y, La, Ti, Zr, or Hf).

In another preferred embodiment of a luminaire in accordance with the invention, the diff-use reflective coating comprises calcium halophosphate, calcium pyrophosphate, BaSO₄, MgO, YBO₃, TiO₂, or Al₂O₃ particles. These particles are physically resistant against high temperatures, whilst important chemical properties thereof do not deteriorate as a result of being exposed to high temperatures, UV light and/or moisture. These particles have an average diameter ranging from 0.1 to 100 μm, in particular from 0.1 to 20 μm.

The invention also relates to a device with an LCD screen, or to a ceiling element or wall element having such a luminaire.

The invention will now be explained in more detail with reference to embodiments illustrated in the drawings, in which:

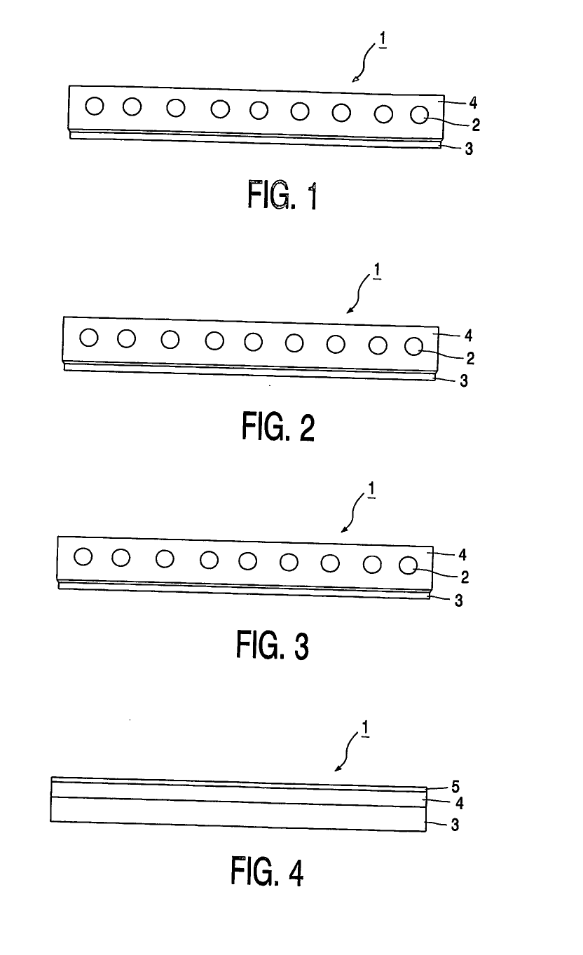

FIGS. 1 through 3 are schematic cross-sectional views of a light box according to the invention; and

FIG. 4 is a schematic side view of a further embodiment of the light box of FIG. 2.

In FIG. 1 a light box 1 is shown, wherein ten light sources in the form of TL tubes 2 are arranged for emitting a light beam through a light-transmitting plate 3 of the light box 1. The inner back surface of the light box 1 is coated with a reflector coating 4, so that the lamps 2 are partially surrounded by said coating 4 for reflecting light emitted by the TL tubes 2 in a direction away from the light-transmitting plate 3 back to the light-transmitting plate 3. Said coating 4 comprises a water-based solvent, for example de-ionized water, and a binder on the basis of a fluorpolymer, named Lumiflon 4200, supplied by the Asahi Glass Company (Japan). CR6-P (Baikowski) is added as a white pigment, and further additives are used, for example Texanol (Eastman Chemicals, coalescent), BYK 346 (Byk Chemie, surface tensioner), and Darvan C (RT Vanderbilt, dispersing agent). The coating 4 is crosslinked with polyisocyanate (for example, Bayhydur 3100 (Bayer)) to improve its mechanical properties and UV resistance. Said coating 4 may be applied by wet spraying, spincoating, etcetera. The coating 4 is finally dried at 60° C. so that a good chemical network is formed.

FIG. 2 corresponds to FIG. 1, with the difference that now a similar coating 4 is applied as a diff-user on the light-transmitting plate 3 made of glass or transparent plastic. This coating compromises a water-based solvent, for example de-ionized water, and a binder on the basis of a fluorpolymer, named Lumiflon 4200, supplied by the Asahi Glass Company (Japan). Calcium halophosphate (Philips) is added as a white pigment, and further additives are used, for example: butylglycol (Merck, coalescent), butyldiglycol (Merck, coalescent), BYK 346 (Byk Chemie, surface tensioner), and Disperbyk 190 (Byk Chemie, dispersing agent). This coating 4 may be applied by wet spraying, spincoating, dipping, flow coating, etcetera. After spraying the coating 4 is cured by a combination of airflow and infrared lamps.

FIG. 3 corresponds to FIG. 2, with the difference that now a different coating 4 is applied as a diffuser on the light-transmitting plate 3 made of glass. Now the coating 4 has a binder on the basis of an organically modified silane of the sol-gel type, for example methyltrimethoxysilane (MTMS). The following additives may be added: Ludox (silica nanoparticles) and calcium halophosphate as a white pigment. This coating may be applied by spin coating or wet spraying and needs to be cured at a temperature of 350° C. Because of its high curing temperature the coating 4 is applied on glass as the light-transmitting plate 3.

FIG. 4 as a side view corresponds to the cross-sectional view of FIG. 2, with the difference that now a UV-blocking layer 5 is applied on top of the diffuse reflective coating 4. Said layer comprises, for example, ZnO (Nyacol) or TiO₂ (Kemira) particles having an average diameter ranging from 10 nm through 100 nm, particularly approximately 80 nm.

The present invention is not restricted to the embodiments shown in the above Figures, but extends also to other embodiments falling within the scope of the appended claims.

1. A luminaire comprising a housing suitable for accommodating at least one light source for emitting a light beam through a light-transmitting plate of the housing, characterized in that a diffuse reflective coating is provided on an inner side of said housing, the diffuse reflective coating having a water-based solvent and a binder based on a polymer having the following structural formula:
-[—CR¹R²—CR³R⁴—]-
wherein R¹ comprises an element chosen from the group Br, Cl, I, F, H, wherein R² comprises an element chosen from the group Br, Cl, I, F, H, or an alkyl group, wherein R³ comprises an element chosen from the group Br, Cl, I, F, H, or COOCH₃, and wherein R⁴ comprises an element chosen from the group Br, Cl, I, F, H, OH, or vinylether.

2. A luminaire according to claim 1, wherein said structural formula contains at least 30% by weight of the group Br, Cl, I, F, or COOCH₃.

3. A luminaire according to claim 1, wherein the solvent comprises at least 80% by weight of water.

4. A luminaire according to claim 1, wherein the diffuse reflective coating is applied as a back reflector on the inner back surface of the housing.

5. A luminaire according to claim 4, wherein the diffuse reflective coating reflects more than 90%, particularly more than 95% of normally incident light thereon.

6. A luminaire according to claim 1, wherein the diffuse reflective coating is cross-linked with a polyisocyanate compound.

7. A luminaire comprising a housing suitable for accommodating at least one light source for emitting a light beam through a light-transmitting plate of the housing, characterized in that said housing is provided with a diffuse reflective coating having a binder on the basis of organically modified silane of the sol-gel type, wherein said diffuse reflective coating is applied as a diffuser on the light-transmitting plate.

8. A luminaire according to claim 7, wherein said organically modified silane has the following structural formula:
R^{I}Si (OR^{II})₃
wherein R^{I} comprises an alkyl group or an aryl group and wherein R^{II} comprises an alkyl group.

9. A luminaire according to claim 1, wherein the diffuse reflective coating is applied as a diffuser on the light-transmitting plate.

10. A luminaire according to claim 9, wherein the diffuse reflective coating transmits more than 60%, particularly more than 70% of normally incident back light thereon.

11. A luminaire according to claim 9, wherein the diffuse reflective coating is provided with a layer that blocks ultraviolet light.

12. A luminaire according to claim 11, wherein said layer is applied on one side and/or both sides of the diffuse reflective coating and/or within the diffuse reflective coating.

13. A luminaire according to claim 11, wherein said layer comprises a metal oxide chosen from the group of ZnO, M₂O₃ (M being B, Al, Sc, La or Y) and MO² (M being Ce, Ge, Sn, Ti, Zr, or Hf) or a metal phosphate chosen from the group of Mₓ(PO₄)ₙ and Mₓ(PO₃)ₙ (M being an alkali metal, an earth alkali metal, Al, Sc, Y, La, Ti, Zr. or Hf).

14. A luminaire according to claim 1, wherein the diffuse reflective coating comprises calcium halophosphate, calcium pyrophosphate, BaSO₄, MgO, YBO₃, TiO₂, or Al₂O₃ particles.

15. Device with an LCD screen having a luminaire according to claim 1.

16. Ceiling element or wall element having a luminaire according to claim 1.
